(19) United States
(12) Patent Application Publication
(10) Pub. No.: US 2025/0305334 A1
(43) Pub. Date: Oct. 2, 2025

(54) VEHICULAR LID OPEN/CLOSE DEVICE

(71) Applicant: TOYODA GOSEI CO., LTD., Kiyosu-shi (JP)

(72) Inventors: Kenichiro KANEKO, Kiyosu-shi (JP); Naoki TOKUDOME, Kiyosu-shi (JP); Kengo SAKAI, Kiyosu-shi (JP); Ryuhei HANADA, Kiyosu-shi (JP); Kazuki FUJISAWA, Kiyosu-shi (JP); Kohei SHIROTA, Kiyosu-shi (JP); Taiji HIMENO, Kiyosu-shi (JP); Daisuke FUJII, Kiyosu-shi (JP)

(21) Appl. No.: 19/080,394

(22) Filed: Mar. 14, 2025

(30) Foreign Application Priority Data
Mar. 27, 2024 (JP) 2024-052580

(51) Int. Cl. E05D 3/14; B60L 53/16; E05D 5/10; E05D 5/14; E05F 15/611; H01R 13/447

(52) U.S. Cl. CPC E05D 3/145; E05D 5/14; E05F 15/611; H01R 13/447; B60L 53/16; E05D 2005/102; E05Y 2900/534

(57) ABSTRACT

This vehicular lid open/close device includes: a box body having a space storing a vehicle-energy-replenishment port, and a front-side opening for exposing the replenishment port in the space outward; a lid movable between closed and opened positions where the front-side opening is closed/opened and the replenishment port is covered/exposed outward; and an open/close mechanism for performing lid-open/close movement relative to the box body between closed and opened positions. The open/close mechanism has a vertically-extending support shaft supporting the lid pivotably relative to the box body, and a bearing portion provided to the lid/box body and supporting the support shaft. The bearing portion has a shaft-end-surface support portion contacting with a lower-end surface of the support shaft and supporting the support shaft from below, and an eaves portion located above the shaft-end-surface support portion and preventing water entry to a contact part between the support shaft and the shaft-end-surface support portion.

### TECHNICAL FIELD

The present disclosure relates to a vehicular lid open/close device.

### BACKGROUND ART

Conventionally, there has been known a vehicular lid open/close device for opening/closing a replenishment port such as a charge port for energy replenishment for a vehicle by using a lid (see, for example, Japanese Laid-Open Patent Publication No. 2014-210473 and Japanese Laid-Open Patent Publication No. 2020-050125). This vehicular lid open/close device includes a box body having a storage space storing a replenishment port, a lid movable between a closed position where a front-side opening of the box body is closed and an opened position where the front-side opening is opened, and an open/close mechanism for performing open/close movement of the lid between the closed position and the opened position. The open/close mechanism has a support shaft supporting the lid pivotably relative to the box body, and a bearing portion supporting the support shaft.

### SUMMARY OF INVENTION

### Technical Problem

If water put between the support shaft and the bearing portion (in particular, a part where the contact area between a flange portion of the support shaft and the bearing portion is large) is frozen, open/close operation by the open/close mechanism is hampered. In particular, in a structure in which water readily enters between the support shaft and the bearing portion and the water is readily accumulated, the freezing range expands and open/close operation is further hampered. In addition, for example, in a case where the open/close mechanism has an arm connecting the box body and the lid, and a pair of the arms are provided so as to be arranged in parallel, a plurality of the support shafts are provided and thus the structure is likely to be complicated, so that hampering of open/close operation due to freezing is likely to occur.

The present disclosure has been made in view of the above circumstances, and an object of the present disclosure is to provide a vehicular lid open/close device that inhibits water from being put between a support shaft and a bearing portion or inhibits such water from being put over a long period, using a simple structure.

### Solution to Problem

An aspect of the present disclosure is a vehicular lid open/close device including: a box body attached to a vehicle body and having a storage space storing a replenishment port for energy replenishment for a vehicle, and a front-side opening through which the replenishment port in the storage space is exposed to a vehicle outer side; a lid movable between a closed position where the front-side opening is closed and the replenishment port is covered, and an opened position where the front-side opening is opened and the replenishment port is exposed to the vehicle outer side; and an open/close mechanism configured to perform open/close movement of the lid relative to the box body between the closed position and the opened position. The open/close mechanism has a support shaft extending in an up-down direction and supporting the lid pivotably relative to the box body, and a bearing portion provided to the lid or the box body and supporting the support shaft. The bearing portion has a shaft-end-surface support portion contacting with a lower-side shaft end surface of the support shaft and supporting the support shaft from a lower side, and an eaves portion located above the shaft-end-surface support portion and configured to prevent entry of water to a part where the support shaft and the shaft-end-surface support portion contact with each other.

With this configuration, water is inhibited from being put between a support shaft and a bearing portion or such water is inhibited from being put over a long period, using a simple structure.

### BRIEF DESCRIPTION OF DRAWINGS

FIG. 1 is a perspective view showing a state in which a vehicular lid open/close device according to an embodiment of the present disclosure is attached to a vehicle body and a lid is at a closed position, as seen from the vehicle outer side;

FIG. 2 is a perspective view showing a state in which the lid of the vehicular lid open/close device of the embodiment is at an opened position, as seen from the vehicle outer side;

FIG. 3 is an exploded view of the vehicular lid open/close device of the embodiment from the vehicle outer side;

FIG. 4 is an exploded view of the vehicular lid open/close device of the embodiment from the vehicle inner side;

FIG. 5 is a bottom view of the vehicular lid open/close device of the embodiment;

FIG. 6 is a perspective view of the lid and an arm included in the vehicular lid open/close device of the embodiment as seen from the vehicle inner side;

FIG. 7 is a perspective view of the lid (including support shafts) included in the vehicular lid open/close device of the embodiment as seen from the vehicle inner side;

FIG. 8 is a bottom view of the lid included in the vehicular lid open/close device of the embodiment;

FIG. 9 is a sectional view of a specific part of an open/close mechanism included in the vehicular lid open/close device of the embodiment; and

FIG. 10 is a sectional view of a specific part of an open/close mechanism included in a vehicular lid open/close device according to a modification of the present disclosure.

### DESCRIPTION OF EMBODIMENTS

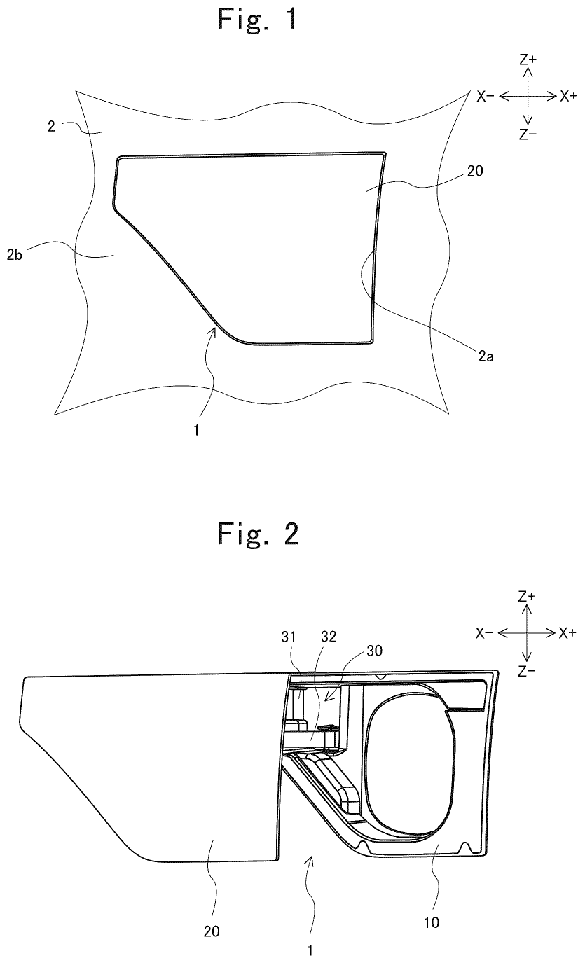

Hereinafter, with reference to FIG. 1 to FIG. 10, a specific embodiment and the like of a vehicular lid open/close device according to the present disclosure will be described.

A vehicular lid open/close device 1 of the present embodiment is a device for opening/closing a replenishment port provided to a vehicle by using a lid. The vehicle to which the vehicular lid open/close device 1 is provided is a gasoline vehicle, a diesel vehicle, an electric vehicle, a hybrid vehicle, or a fuel cell vehicle, for example. The replenishment port which is a target to be opened/closed by the vehicular lid open/close device 1 is provided at a side surface, a forward surface, or the like of a vehicle body 2 (see FIG. 1), and is located at a vehicle body opening 2a (see FIG. 1) penetrating the vehicle body 2 in the in-out direction (i.e., front-back direction). The vehicle body opening 2a may be opened in a lateral direction of the vehicle, or may be opened in a direction such as a forward direction, a rearward direction, or an obliquely upward direction of the vehicle.

The replenishment port is a fuel port or a charge port provided for energy replenishment such as refueling or battery charging to the vehicle. The replenishment port is provided at one end of a tube or an electric wire. Another end of the tube or the electric wire is connected to a fuel tank, a battery, or the like provided on the vehicle body back side (i.e., vehicle body inner side). The replenishment port may be covered by a cap openable/closable by an operator. A refueling gun or a charging gun for energy replenishment is connected to the replenishment port in a cap opened state.

Hereinafter, as appropriate, when the vehicular lid open/close device 1 attached to the vehicle body 2 is seen from the vehicle outer side, a horizontal left-right direction is referred to as an X direction, a horizontal in-out direction of the vehicle body 2 is referred to as a Y direction, and a vertical up-down direction is referred to as a Z direction. In addition, a left direction of the X direction is referred to as an X− direction, a right direction thereof is referred to as an X+ direction, a vehicle body inward direction of the Y direction is referred to as a Y− direction, a vehicle body outward direction thereof is referred to as a Y+ direction, a downward direction of the Z direction is referred to as a Z− direction, and an upward direction thereof is referred to as a Z+ direction.

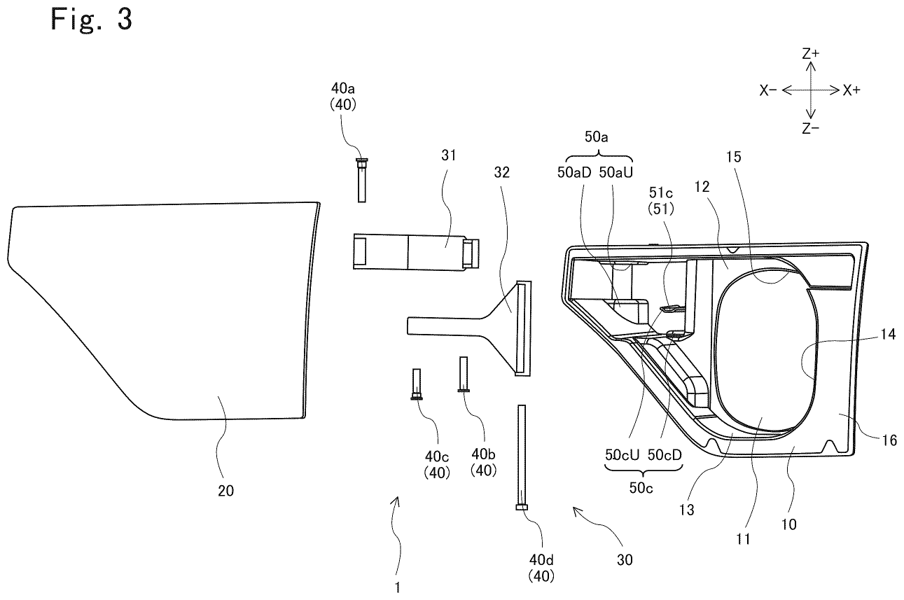

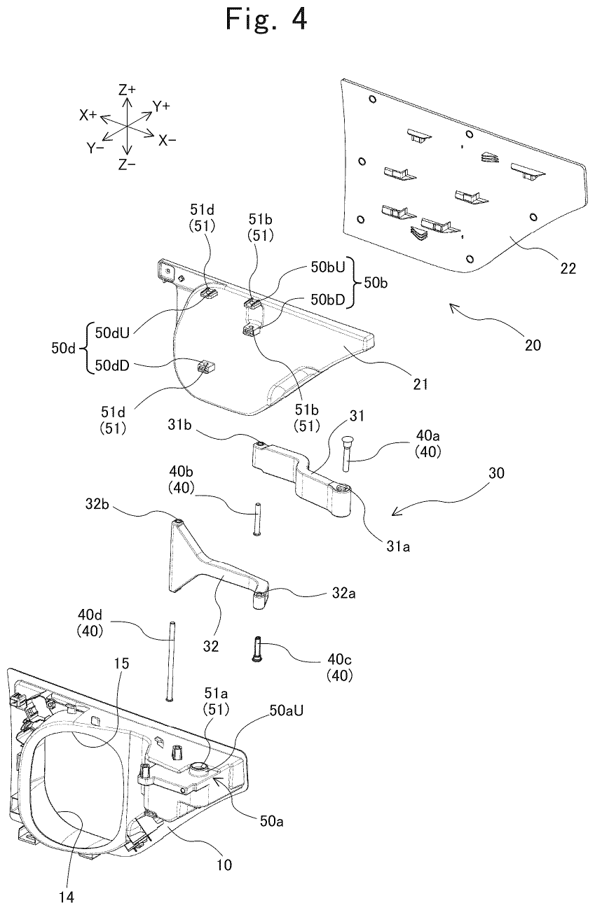

The vehicular lid open/close device 1 includes a box body 10, a lid 20, and an open/close mechanism 30, as shown in FIG. 2, FIG. 3, and FIG. 4.

The box body 10 is a box-shaped base body storing the replenishment port. The box body 10 is attached to the vehicle body 2. Specifically, the box body 10 is attached so as to be fitted to the vehicle body opening 2a provided to the vehicle body 2. The box body 10 has a storage space 11, a bottom wall 12, a side wall 13, a front-side opening 14, a back-side opening 15, and a frame 16.

The storage space 11 is a space storing the replenishment port. The storage space 11 is surrounded by the bottom wall 12 and the side wall 13. The bottom wall 12 is a plate wall part having a polygonal shape (e.g., a quadrangular plate shape), a circular shape, or an elliptic shape. The bottom wall 12 is formed in, for example, a shape having a long upper side and a short lower side (i.e., a reverse trapezoidal shape), as shown in FIG. 2, FIG. 3, etc. The side wall 13 is a wall part erected from the edge of the bottom wall 12 toward the vehicle outer side (Y+ direction side) so as to surround the peripheral edge of the bottom wall 12. For example, in a case where the bottom wall 12 is formed in a quadrangular plate shape, the side wall 13 is formed such that four plate walls are connected in a peripheral direction along the edge of the bottom wall 12. The side wall 13 is formed by, for example, a wall extending in the horizontal direction, a wall extending in the vertical direction, a wall extending in a direction oblique to the horizontal direction, and the like.

The front-side opening 14 is an opening through which the replenishment port in the storage space 11 is exposed to the vehicle outer side. The front-side opening 14 is provided on a side opposite to the bottom wall 12 across the storage space 11 in the box body 10. The front-side opening 14 is closed when the lid 20 is at the closed position, and is opened when the lid 20 is not at the closed position. When the front-side opening 14 is opened, the replenishment port in the storage space 11 is exposed to the vehicle outer side through the front-side opening 14. The box body 10 is attached to the vehicle body 2 such that the front-side opening 14 faces in the horizontal direction or a direction tilted upward relative to the horizontal direction from the vehicle body inner side toward the vehicle body outer side, for example.

The back-side opening 15 is an opening through which the replenishment port is exposed from the vehicle inner side to the storage space 11. The back-side opening 15 is provided in the bottom wall 12 of the box body 10 so as to penetrate between the vehicle inner side and the vehicle outer side. The back-side opening 15 is formed in, for example, a circular shape, an elliptic shape, a rectangular shape, or the like in the bottom wall 12 of the box body 10, in accordance with the sectional shape of the replenishment port, or the like.

The frame 16 is formed in an annular shape along the peripheral edge of the front-side opening 14. The frame 16 is formed in a flange shape so as to extend from the peripheral edge of the front-side opening 14 toward the frame outer side. The box body 10 is positioned at the vehicle body 2 by the back surface of the frame 16 contacting with the front surface of the peripheral edge of the vehicle body opening 2a of the vehicle body 2, for example.

The lid 20 is a lid member for opening/closing the front-side opening 14 and therefore the replenishment port. The lid 20 is movable between the closed position where the front-side opening 14 is closed and the replenishment port is covered, and the opened position (specifically, fully opened position) where the front-side opening 14 is opened and the replenishment port is exposed to the vehicle outer side. The lid 20 performs open/close movement relative to the box body 10 by a later-described open/close mechanism 30 operating with an external force based on an operation by an operator or motive power produced by an electric motor, for example.

The lid 20 is formed in a plate shape so as to close the front-side opening 14 of the box body 10. The lid 20 is formed in a size and a shape (e.g., a substantially rectangular shape) corresponding to the front-side opening 14. The lid 20 closes the front-side opening 14 so as to be flush with the vehicle body surface 2b and the frame 16 around the peripheral edge of the front-side opening 14, at the closed position of the lid 20. The front surface of the lid 20 may be curved along the vehicle body surface 2b.

The lid 20 is formed by a lid lower portion 21 on the back side and a lid upper portion 22 on the front side, as shown in FIG. 4. The lid 20 is formed by the lid lower portion 21 and the lid upper portion 22 being attached and integrated with each other. When the lid 20 contacts with a full-open stopper so that movement of the lid 20 is restricted, the lid 20 may reach the fully opened position and be retained, or when an energizing force by an energizing member (not shown) becomes zero, the lid 20 may reach the fully opened position and be retained.

The open/close mechanism 30 is a mechanism for performing open/close movement of the lid 20 between the closed position and the opened position. Specifically, the open/close mechanism 30 slides the lid 20 in the substantially horizontal X direction along the vehicle body surface 2b which is a front surface of the vehicle body 2, between the closed position and the opened position. The open/close mechanism 30 may provide motive power of at least one of an opening force or a closing force to the lid 20, using an electric motor. The open/close mechanism 30 has arms 31 and 32.

The arms 31 and 32 are arm-shaped members extending so as to connect the box body 10 and the lid 20 and supporting the lid 20 openably/closably relative to the box body 10. The arms 31 and 32 are stored in the storage space 11 of the box body 10 at the closed position of the lid 20. The arms 31 and 32 are configured to slide the lid 20 along the vehicle body surface 2b relative to the box body 10 when the lid 20 is opened/closed. The arms 31 and 32 form a pair of arms. Hereinafter, the arm 31 is referred to as a first arm 31, and the arm 32 is referred to as a second arm 32.

The first arm 31 and the second arm 32 perform, by pivoting, open/close movement of the lid 20 relative to the box body 10 between the closed position and the opened position, and specifically, cause the lid 20 to slide along the vehicle body surface 2b while keeping a state of being parallel to the front-side opening 14 of the box body 10 during pivoting. The first arm 31 and the second arm 32 pivot in synchronization with each other. The first arm 31 and the second arm 32 are formed in arm shapes such as a straight shape, a curved shape, or a bent shape, and extend in the horizontal direction on an XY plane, between the box body 10 and the lid 20. The first arm 31 and the second arm 32 extend in parallel to each other.

The first arm 31 and the second arm 32 extend in the X direction at least at the closed position of the lid 20. In a case where support shafts extend in the vertical Z direction as described later, the first arm 31 and the second arm 32 may be kept on the XY plane while the lid 20 is moving between the closed position and the fully opened position, or in a case where the support shafts are tilted relative to the Z direction, the first arm 31 and the second arm 32 may be tilted relative to the horizontal direction at any opened position other than the closed position of the lid 20.

The first arm 31 is located on the upper side and the second arm 32 is located on the lower side. That is, the second arm 32 is located below the first arm 31. The first arm 31 and the second arm 32 are located so as to be shifted from each other in the horizontal direction.

The open/close mechanism 30 has a support shaft 40 and a bearing portion 50. The support shaft 40 is a shaft supporting the lid 20 pivotably relative to the box body 10. The bearing portion 50 is a part supporting the support shaft 40.

The support shaft 40 extends in the up-down direction. The support shaft 40 may extend in the vertical Z direction or may extend slightly obliquely relative to the Z direction. The support shaft 40 is provided separately from the box body 10 and the lid 20. The support shaft 40 has a circular sectional shape or an annular sectional shape. The support shafts 40 are inserted into both ends of the first arm 31, and the support shafts 40 are inserted into both ends of the second arm 32.

Hereinafter, the support shaft 40 inserted into the end on the box body 10 side of the first arm 31 is referred to as a box-side first support shaft 40a, the support shaft 40 inserted into the end on the lid 20 side of the first arm 31 is referred to as a lid-side first support shaft 40b, the support shaft 40 inserted into the end on the box body 10 side of the second arm 32 is referred to as a box-side second support shaft 40c, and the support shaft 40 inserted into the end on the lid 20 side of the second arm 32 is referred to as a lid-side second support shaft 40d.

The first arm 31 has a box-side shaft hole 31a into which the box-side first support shaft 40a is inserted, and a lid-side shaft hole 31b into which the lid-side first support shaft 40b is inserted. The second arm 32 has a box-side shaft hole 32a into which the box-side second support shaft 40c is inserted, and a lid-side shaft hole 32b into which the lid-side second support shaft 40d is inserted. The shaft holes 31a, 31b, 32a, 32b are through holes. The diameters of the shaft holes 31a, 31b, 32a, 32b are set in accordance with the outer diameters of the support shafts 40 to be inserted.

The bearing portion 50 has a shaft hole 51 into which the support shaft 40 is inserted. The bearing portions 50 are provided to the box body 10, and the bearing portions 50 are provided to the lid 20. The bearing portions 50 retain the box-side end of the first arm 31 and the box-side end of the second arm 32 pivotably relative to the box body 10, and the bearing portions 50 retain the lid-side end of the first arm 31 and the lid-side end of the second arm 32 pivotably relative to the lid 20.

Hereinafter, as shown in FIG. 3 and FIG. 4, the bearing portion 50 provided to the box body 10 and retaining the box-side end of the first arm 31 is referred to as a box-side first bearing portion 50a, the bearing portion 50 provided to the lid 20 and retaining the lid-side end of the first arm 31 is referred to as a lid-side first bearing portion 50b, the bearing portion 50 provided to the box body 10 and retaining the box-side end of the second arm 32 is referred to as a box-side second bearing portion 50c, and the bearing portion 50 provided to the lid 20 and retaining the lid-side end of the second arm 32 is referred to as a lid-side second bearing portion 50d

The box-side first bearing portion 50a is provided as a pair of portions separated between the upper and lower sides at the box body 10, and is composed of an upper-side bearing portion 50aU and a lower-side bearing portion 50aD. The upper-side bearing portion 50aU and the lower-side bearing portion 50aD have shaft holes 51a into which the box-side first support shaft 40a is inserted. The diameters of the shaft holes 51a are set in accordance with the outer diameter of the box-side first support shaft 40a. The upper-side bearing portion 50aU supports an upper part of the box-side first support shaft 40a. The lower-side bearing portion 50aD supports a lower part of the box-side first support shaft 40a. The lower-side bearing portion 50aD is located below the upper-side bearing portion 50aU and separately from the upper-side bearing portion 50aU.

The lid-side first bearing portion 50bis provided as a pair of portions separated between the upper and lower sides at the lid 20, and is composed of an upper-side bearing portion 50bU and a lower-side bearing portion 50bD. The upper-side bearing portion 50bU and the lower-side bearing portion 50bD are provided so as to protrude in the Y− direction on the back surface (i.e., the surface facing in the Y− direction) of the lid lower portion 21 of the lid 20. The upper-side bearing portion 50bU and the lower-side bearing portion 50bD have shaft holes 51b into which the lid-side first support shaft 40b is inserted. The diameters of the shaft holes 51b are set in accordance with the outer diameter of the lid-side first support shaft 40b. The upper-side bearing portion 50bU supports an upper part of the lid-side first support shaft 40b. The lower-side bearing portion 50bD supports a lower part of the lid-side first support shaft 40b. The lower-side bearing portion 50bD is located below the upper-side bearing portion 50bU and separately from the upper-side bearing portion 50bU.

The box-side second bearing portion 50c is provided as a pair of portions separated between the upper and lower sides at the box body 10, and is composed of an upper-side bearing portion 50cU and a lower-side bearing portion 50cD. The upper-side bearing portion 50cU and the lower-side bearing portion 50cD have shaft holes 51c into which the box-side second support shaft 40c is inserted. The diameters of the shaft holes 51c are set in accordance with the outer diameter of the box-side second support shaft 40c. The upper-side bearing portion 50cU supports an upper part of the box-side second support shaft 40c. The lower-side bearing portion 50cD supports a lower part of the box-side second support shaft 40c. The lower-side bearing portion 50cD is located below the upper-side bearing portion 50cU and separately from the upper-side bearing portion 50cU.

The lid-side second bearing portion 50d is provided as a pair of portions separated between the upper and lower sides at the lid 20, and is composed of an upper-side bearing portion 50dU and a lower-side bearing portion 50dD. The upper-side bearing portion 50dU and the lower-side bearing portion 50dD are provided so as to protrude in the Y− direction on the back surface (i.e., the surface facing in the Y− direction) of the lid lower portion 21 of the lid 20. The upper-side bearing portion 50dU and the lower-side bearing portion 50dD have shaft holes 51d into which the lid-side second support shaft 40d is inserted. The diameters of the shaft holes 51d are set in accordance with the outer diameter of the lid-side second support shaft 40d. The upper-side bearing portion 50dU supports an upper part of the lid-side second support shaft 40d. The lower-side bearing portion 50dD supports a lower part of the lid-side second support shaft 40d. The lower-side bearing portion 50dD is located below the upper-side bearing portion 50dU and separately from the upper-side bearing portion 50dU.

The first arm 31 is pivotably supported by the box body 10 with the box-side first support shaft 40a inserted into the box-side shaft hole 31aand inserted into the shaft holes 51a of the upper-side bearing portion 50aU and the lower-side bearing portion 50aD of the box-side first bearing portion 50a, and is pivotably supported by the lid 20 with the lid-side first support shaft 40b inserted into the lid-side shaft hole 31b and inserted into the shaft holes 51b of the upper-side bearing portion 50bU and the lower-side bearing portion 50bD of the lid-side first bearing portion 50b.

The second arm 32 is pivotably supported by the box body 10 with the box-side second support shaft 40c inserted into the box-side shaft hole 32a and inserted into the shaft holes 51c of the upper-side bearing portion 50cU and the lower-side bearing portion 50cD of the box-side second bearing portion 50c, and is pivotably supported by the lid 20 with the lid-side second support shaft 40d inserted into the lid-side shaft hole 32b and inserted into the shaft holes 51d of the upper-side bearing portion 50dU and the lower-side bearing portion 50dD of the lid-side second bearing portion 50d.

Each support shaft 40 has a shaft pin portion 41 and a flange portion 42. The shaft pin portion 41 is a part extending in the up-down direction. The flange portion 42 is a part integrated with one axial-direction end of the shaft pin portion 41 and extending radially outward. The flange portion 42 protrudes radially outward relative to the outer circumferential surface of the shaft pin portion 41. The flange portion 42 of the box-side first support shaft 40a is integrated with the axial-direction upper end of the shaft pin portion 41. The flange portions 42 of the lid-side first support shaft 40b, the box-side second support shaft 40c, and the lid-side second support shaft 40d are integrated with axial-direction lower ends of the shaft pin portions 41.

The diameters of the shaft pin portions 41 are equal to or slightly smaller than the diameters of the shaft holes 31a, 31b, 32a, and 32b of the corresponding arms 31 and 32 and the shaft holes 51 of the corresponding bearing portions 50. On the other hand, the outer diameters of the flange portions 42 are larger than the diameters of the shaft holes 31a, 31b, 32a, and 32b of the corresponding arms 31 and 32 and the shaft holes 51 of the corresponding bearing portions 50. The flange portions 42 have a function of preventing the support shafts 40 from coming off the shaft holes 31a, 31b, 32a, and 32b of the arms 31 and 32 and the shaft holes 51 of the bearing portions 50.

The box-side first support shaft 40a is attached to the box body 10 and the lid 20 such that the flange portion 42 is located at the upper end of the shaft pin portion 41. The box-side first support shaft 40a is inserted from the upper side (i.e., the outer side of the storage space 11) of the side wall 13 that is the upper wall of the box body 10, into: the shaft hole 51a of the upper-side bearing portion 50aU, of the box-side first bearing portion 50a, provided at the side wall 13; the box-side shaft hole 31aof the first arm 31; and then the shaft hole 51a of the lower-side bearing portion 50aD, of the box-side first bearing portion 50a, provided on the storage space 11 side of the side wall 13 of the box body 10, in this order.

The lid-side first support shaft 40b, the box-side second support shaft 40c, and the lid-side second support shaft 40d are each attached to the box body 10 and the lid 20 such that the flange portion 42 is located at the lower end of the shaft pin portion 41. The box-side second support shaft 40c is inserted from the lower side (i.e., the outer side of the storage space 11) of the side wall 13 that is the lower wall or the sloped wall of the box body 10, into: the shaft hole 51c of the lower-side bearing portion 50cD, of the box-side second bearing portion 50c, provided at the side wall 13; the box-side shaft hole 32a of the second arm 32; and then the shaft hole 51c of the upper-side bearing portion 50cU, of the box-side second bearing portion 50c, provided on the storage space 11 side of the bottom wall 12 of the box body 10, in this order.

The lid-side first support shaft 40b is inserted into: the shaft hole 51b of the lower-side bearing portion 50bD of the lid-side first bearing portion 50b protruding in the horizontal direction from the back surface of the lid lower portion 21 of the lid 20; the lid-side shaft hole 31b of the first arm 31; and then the shaft hole 51b of the upper-side bearing portion 50bU, in this order. The lid-side second support shaft 40d is inserted into: the shaft hole 51d of the lower-side bearing portion 50dD of the lid-side second bearing portion 50d protruding in the horizontal direction from the back surface of the lid lower portion 21 of the lid 20; the lid-side shaft hole 32b of the second arm 32; and then the shaft hole 51d of the upper-side bearing portion 50dU, in this order.

The box-side first support shaft 40a and the box-side second support shaft 40c are located so as to be shifted from each other in the horizontal direction (specifically, the X direction) at the box body 10. The lid-side first support shaft 40b and the lid-side second support shaft 40d are located so as to be shifted from each other in the horizontal direction (specifically, the X direction) at the lid 20. The first arm 31 and the second arm 32 are configured to keep a parallelogram having corners at the four support shafts 40a, 40b, 40c, 40d, during open/close movement of the lid 20 between the closed position and the fully opened position.

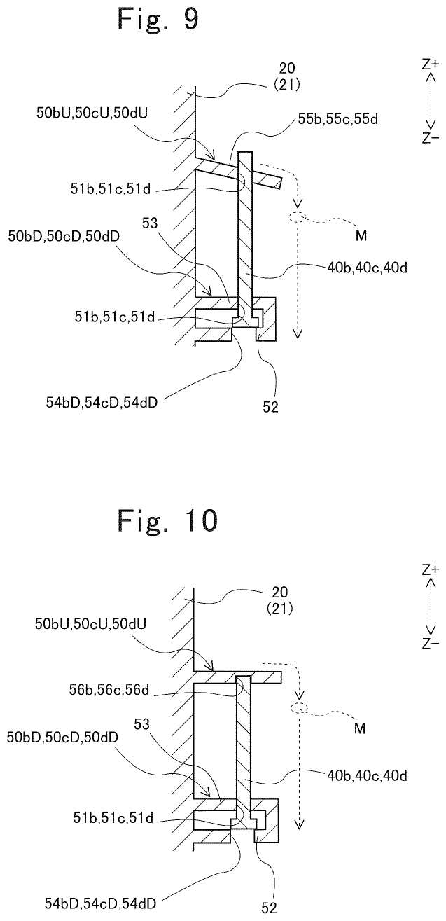

The bearing portion 50 has a shaft-end-surface support portion 52 and an eaves portion 53, as shown in FIG. 9. The shaft-end-surface support portion 52 is a part contacting with the lower-side shaft end surface of the support shaft 40 and supporting the support shaft 40 from the lower side. The eaves portion 53 is a part for preventing entry of water to a part where the support shaft 40 and the shaft-end-surface support portion 52 contact with each other. The eaves portion 53 is located above the shaft-end-surface support portion 52.

The shaft-end-surface support portions 52 and the eaves portions 53 are provided for the lid-side first bearing portion 50b, the box-side second bearing portion 50c, and the lid-side second bearing portion 50d to which the support shafts 40 are attached by being inserted from the lower side toward the upper side, among all the bearing portions 50. The shaft-end-surface support portions 52 and the eaves portions 53 are provided to the lower-side bearing portions 50bD, 50cD, 50dD. The shaft-end-surface support portion 52 and the eaves portion 53 are located separately from each other by a distance greater than the axial-direction thickness of the flange portion 42 of each support shaft 40b, 40c, 40d.

The lower-side bearing portions 50bD, 50cD, 50dD have large-diameter groove portions 54bD, 54cD, 54dD. Each large-diameter groove portion 54bD, 54cD, 54dD is a groove portion provided at the lower-side end of the lower-side bearing portion 50bD, 50cD, 50dD and integrated in communication with the shaft hole 51b, 51c, 51d. Each large-diameter groove portion 54bD, 54cD, 54dD is formed in such a size that allows the flange portion 42 of the support shaft 40b, 40c, 40d to be inserted therethrough. That is, the diameters of the large-diameter groove portions 54bD, 54cD, 54dD are greater than the outer diameters of the flange portions 42 of the support shafts 40b, 40c, 40d.

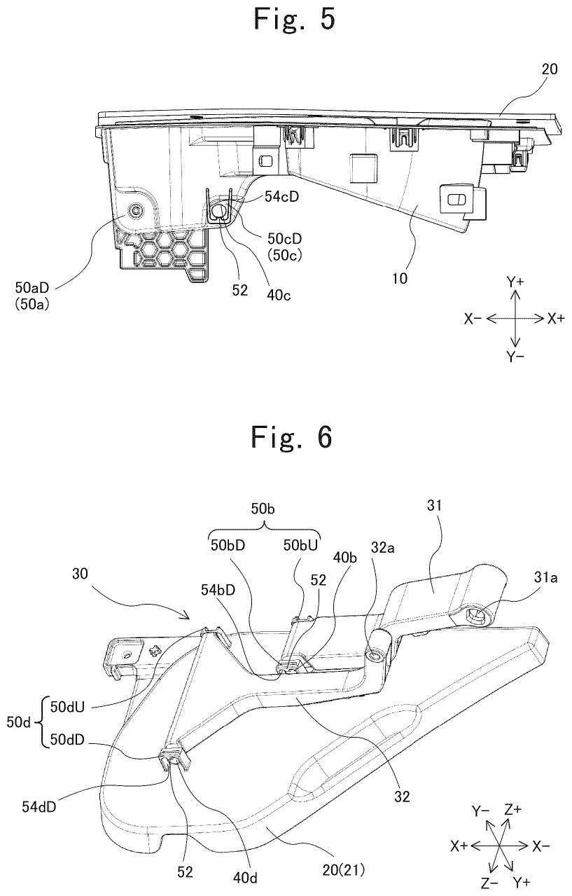

Each shaft-end-surface support portion 52 protrudes radially inward of the large-diameter groove portion 54bD, 54cD, 54dD from a wall forming the large-diameter groove portion 54bD, 54cD, 54dD of the lower-side bearing portion 50bD, 50cD, 50dD. The shaft-end-surface support portion 52 may be formed over the entire periphery of the wall forming the large-diameter groove portion 54bD, 54cD, 54dD, but is preferably formed at a part of the wall so that the contact area between the support shaft 40 and the bearing portion 50 becomes as small as possible (see FIG. 5 to FIG. 8).

Each shaft-end-surface support portion 52 is provided at a part elastically deformable in the up-down direction, of the lower-side bearing portion 50bD, 50CD, 50dD. That is, in attachment in which the shaft pin portion 41 of the support shaft 40b, 40c, 40d is inserted into the shaft hole 51, when the flange portion 42 is inserted into the large-diameter groove portion 54bD, 54cD, 54dD, the shaft-end-surface support portion 52 is pressed upward by the upper surface of the flange portion 42 so as to be deformed, and the flange portion 42 passes through the large-diameter groove portion 54bD, 54cD, 54dD and then supports the flange portion 42 from the lower side. The support shafts 40b, 40c, 40d are attached to the lower-side bearing portions 50bD, 50cD, 50dD by so-called snap-fit.

Each eaves portion 53 is a part extending in a plate shape at which the shaft hole 51b, 51c, 51d is formed. That is, the eaves portion 53 has the shaft hole 51b, 51c, 51d. The shaft hole 51b, 51c, 51d is a lower-side through hole penetrating in the Z direction. The eaves portion 53 forms a body part of the lower-side bearing portion 50bD, 50cD, 50dD. The shaft-end-surface support portion 52 and the eaves portion 53 may be integrated with each other and may be formed so as to surround the outer periphery of a side part and an upper part of the flange portion 42 of the support shaft 40b, 40c, 40d.

Among the bearing portions 50, the lid-side first bearing portion 50b and the lid-side second bearing portion 50d formed at the lid 20 are separated in the Y+ direction from the vehicle body surface 2b of the vehicle body 2 at the opened position of the lid 20, and therefore water such as a raindrop is likely to be put on the lid-side first bearing portion 50b and the lid-side second bearing portion 50d. In particular, the upper-side bearing portions 50bU, 50dU have no eaves on the upper side and therefore water is more likely to be put on the upper-side bearing portions 50bU, 50dU.

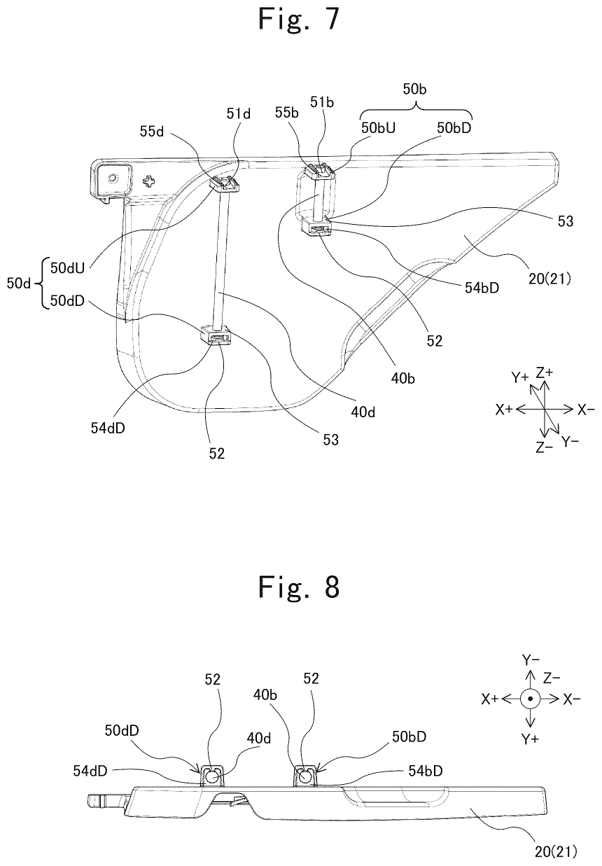

In the present embodiment, as shown in FIG. 7, the lid-side first support shaft 40b and the lid-side second support shaft 40d are respectively inserted into the shaft holes 51 of the lid-side first bearing portion 50b and the lid-side second bearing portion 50d, and upper parts of the support shafts 40b, 40d are respectively exposed upward from the upper-side bearing portions 50bU, 50dU. In this exposed shape, if the upper surface of each upper-side bearing portion 50bU, 50dU is horizontal and has a structure in which water is readily accumulated, open/close operation by the open/close mechanism 30 is hampered when the water is frozen.

Each upper-side bearing portion 50bU, 50dU has the shaft hole 51b, 51d and a slope portion 55b, 55d. The shaft hole 51b, 51d is an upper-side through hole penetrating in the Z direction. The slope portion 55b, 55d is a part sloped relative to the horizontal direction on the upper surface of the upper-side bearing portion 50bU, 50dU where an upper-side opening of the shaft hole 51b, 51d is formed and the support shaft 40b, 40d protrudes upward from the upper-side opening of the shaft hole 51b, 51d.

The slope portion 55b, 55d is formed such that water put on the upper surface of the upper-side bearing portion 50bU, 50dU is guided to an end of the upper surface without being accumulated on the upper surface, and then is drained from the end. The slope portion 55b, 55d may be sloped in any direction relative to the back surface of the lid 20. Preferably, the upper-side bearing portion 50bU, 50dU is formed to be larger than the lower-side bearing portion 50bD, 50dD so that water falling from the end of the slope portion 55b, 55d does not drop on the lower-side bearing portion 50bD, 50dD.

Among the bearing portions 50, the upper-side bearing portion 50cU of the box-side second bearing portion 50c which is formed at the box body 10 and of which the upper-side bearing portion 50cU is exposed on the storage space 11 side of the bottom wall 12 preferably has the shaft hole 51c which is an upper-side through hole penetrating in the Z direction and the slope portion 55c sloped relative to the horizontal direction on the upper surface where the support shaft 40c protrudes upward from the shaft hole 51c, as with the upper-side bearing portions 50bU, 50dU.

In the open/close mechanism 30 of the vehicular lid open/close device 1 described above, the lower-side bearing portions 50bD, 50cD, 50dD of the bearing portions 50 each have the shaft-end-surface support portion 52 contacting with the lower-side shaft end surface of the support shaft 40 and supporting the support shaft 40 from the lower side, and the eaves portion 53 located above the shaft-end-surface support portion 52 and configured to prevent entry of water to a part where the support shaft 40 and the shaft-end-surface support portion 52 contact with each other.

With this configuration, a part where the support shaft 40 is supported in contact with the upper surface of the shaft-end-surface support portion 52 is covered by the eaves portion 53 on the upper side, and therefore, even if water falls or flies to be put on the part, the water is blocked by the eaves portion 53 so that entry of the water to the part is prevented. Thus, water is inhibited from being put between the support shaft 40 and the shaft-end-surface support portion 52 of the bearing portion 50, whereby open/close operation of the lid 20 is prevented from being hampered due to freezing and solidification of a large amount of water and open/close operation by the open/close mechanism 30 is ensured.

The eaves portion 53 has the shaft hole 51 which is a lower-side through hole into which the support shaft 40 is inserted, and forms a body part of the lower-side bearing portions 50bD, 50cD, 50dD. Therefore, the eaves portion 53 need not be provided as a separate part from the body part of the lower-side bearing portions 50bD, 50cD, 50dD, and putting of water between the support shaft 40 and the shaft-end-surface support portion 52 of the bearing portion 50 is prevented using a simple structure.

In the open/close mechanism 30, the upper-side bearing portion 50bU, 50cU, 50dU of the bearing portion 50 has the shaft hole 51b, 51c, 51d which is an upper-side through hole into which the support shaft 40 is inserted, and the slope portion 55 sloped relative to the horizontal direction on the upper surface where the support shaft 40 protrudes upward from the shaft hole 51b, 51c, 51d.

With this configuration, when water is put on the upper surface of the upper-side bearing portion 50bU, 50cU, 50dU, the water M readily flows along the slope portion 55 and falls from the end thereof as shown in FIG. 9, so that the maximum amount of water M accumulated on the upper surface of the upper-side bearing portion 50bU, 50cU, 50dU is reduced and water becomes less likely to be accumulated between the support shaft 40 and the bearing portion 50. Thus, water is inhibited from being put on the upper surface of the upper-side bearing portion 50bU, 50cU, 50dU over a long period, whereby open/close operation of the lid 20 is prevented from being hampered due to freezing and solidification of a large amount of water and open/close operation by the open/close mechanism 30 is ensured.

The slope portion 55 is sloped relative to the horizontal direction on the upper surface of the upper-side bearing portion 50bU, 50cU, 50dU where the support shaft 40 protrudes upward from the shaft hole 51 into which the support shaft 40 is inserted. Therefore, the slope portion 55 need not be provided as a separate part from the upper-side bearing portion 50bU, 50cU, 50dU, and putting of water between the support shaft 40 and the bearing portion 50 is prevented using a simple structure.)

The flange portion 42 of each of the lid-side first support shaft 40b, the box-side second support shaft 40c, and the lid-side second support shaft 40d is integrated with the axial-direction lower end of the shaft pin portion 41. Each support shaft 40b, 40c, 40d is attached by being inserted into the bearing portion 50 from the lower side of the bearing portion 50.

With this configuration, after the support shaft 40 is attached to the bearing portion 50, the lower surface of the flange portion 42 is supported in contact with the shaft-end-surface support portion 52, and the upper surface of the flange portion 42 is less likely to contact with a part around the shaft hole 51 of the bearing portion 50, so that a large gap is formed between the flange portion 42 of the support shaft 40 and the bearing portion 50. The contact area between the flange portion 42 and the bearing portion 50 is reduced and the gap space is enlarged, so that water becomes less likely to be accumulated. Thus, also in this regard, water is inhibited from being put between the support shaft 40 and the bearing portion 50, whereby open/close operation of the lid 20 is prevented from being hampered due to freezing and solidification of a large amount of water and open/close operation by the open/close mechanism 30 is ensured.

In the above embodiment, as shown in FIG. 9, etc., the upper-side bearing portions 50bU, 50dU provided to the lid 20 and the upper-side bearing portion 50cU provided to the box body 10 each have the shaft hole 51b, 51c, 51d penetrating in the Z direction, the upper part of the support shaft 40b, 40c, 40d protrudes upward from the upper-side opening of the shaft hole 51b, 51c, 51d, and the slope portion 55b, 55c, 55d sloped relative to the horizontal direction is provided at the upper surface of the upper-side bearing portion 50bU, 50cU, 50dU.

However, the present disclosure is not limited thereto. As shown in FIG. 10, each upper-side bearing portion 50bU, 50cU, 50dU may have a shaft recess 56b, 56c, 56d which does not penetrate in the Z direction and into which the upper part of the support shaft 40b, 40c, 40d is inserted, and the upper surface of the upper-side bearing portion 50bU, 50cU, 50dU may extend in the horizontal direction.

In this modification, although the slope portion 55 is not provided to the upper-side bearing portion 50bU, 50cU, 50dU, the upper part of the support shaft 40b, 40c, 40d does not protrude upward from the upper surface of the upper-side bearing portion 50bU, 50cU, 50dU, and therefore entry of water to a part where the support shaft 40b, 40c, 40d and the upper-side bearing portion 50bU, 50cU, 50dU contact with each other does not occur. Thus, open/close operation of the lid 20 is prevented from being hampered due to freezing and solidification of a large amount of water and open/close operation by the open/close mechanism 30 is ensured.

The present disclosure is not limited to the embodiments and the modifications described above, and various changes may be made without departing from the gist of the present disclosure. The description discloses not only technical features shown by the reference relationship described in the claims at the time of filing of the present application but also technical features obtained by combining matters described n the claims as appropriate.

This application claims priority on Japanese Patent Application No. 2024-052580 filed in Japan on Mar. 27, 2024, the entire contents of which are incorporated herein by reference.

1. A vehicular lid open/close device comprising:
a box body attached to a vehicle body and having a storage space storing a replenishment port for energy replenishment for a vehicle, and a front-side opening through which the replenishment port in the storage space is exposed to a vehicle outer side;
a lid movable between a closed position where the front-side opening is closed and the replenishment port is covered, and an opened position where the front-side opening is opened and the replenishment port is exposed to the vehicle outer side; and
an open/close mechanism configured to perform open/close movement of the lid relative to the box body between the closed position and the opened position, wherein
the open/close mechanism has
a support shaft extending in an up-down direction and supporting the lid pivotably relative to the box body, and
a bearing portion provided to the lid or the box body and supporting the support shaft, and
the bearing portion has
a shaft-end-surface support portion contacting with a lower-side shaft end surface of the support shaft and supporting the support shaft from a lower side, and
an eaves portion located above the shaft-end-surface support portion and configured to prevent entry of water to a part where the support shaft and the shaft-end-surface support portion contact with each other.

2. The vehicular lid open/close device according to claim 1, wherein
the bearing portion has
an upper-side bearing portion supporting an upper part of the support shaft, and
a lower-side bearing portion located below the upper- side bearing portion and separately from the upper-side bearing portion, the lower-side bearing portion supporting a lower part of the support shaft, and
the shaft-end-surface support portion and the eaves portion are provided to the lower-side bearing portion.

3. The vehicular lid open/close device according to claim 2, wherein
the upper-side bearing portion has
an upper-side through hole into which the support shaft is inserted, and
a slope portion sloped relative to a horizontal direction on an upper surface where the support shaft protrudes upward from the upper-side through hole.

4. The vehicular lid open/close device according to claim 1, wherein
the eaves portion has a lower-side through hole into which the support shaft is inserted.

5. The vehicular lid open/close device according to claim 1, wherein
of the support shaft, the support shaft supported by the shaft-end-surface support portion has
a shaft pin portion extending in the up-down direction, and
a flange portion integrated with an axial-direction lower end of the shaft pin portion and extending radially outward.
